(19) United States
(12) Patent Application Publication
(10) Pub. No.: US 2003/0106591 A1
(43) Pub. Date: Jun. 12, 2003

(54) Unloading valve for ultra-high-pressure applications

(76) Inventors: Albert C. Saurwein, Granger, WA (US); Betty L. Boone-Saurwein, Granger, WA (US)

Correspondence Address: STRATTON BALLEW, 213 S 12TH AVE, YAKIMA, WA, 98902, US

(21) Appl. No.: 10/295,412

(22) Filed: Nov. 15, 2002

Related U.S. Application Data
(60) Provisional application No. 60/333,820, filed on Nov. 16, 2001.

(51) Int. Cl. F16K 15/00

(52) U.S. Cl. 137/540

(57) ABSTRACT

A valve connected into an ultra-high-pressure fluid circuit (20,000 to 60,000 psi) which, when the system pressure is exceeded to some preset level, vents the pumped fluid to atmosphere while reducing and maintaining a system pressure on the order of five percent (5%) of the original system value. Upon shutting down the system and restarting, system pressure will be restored.

### PRIORITY CLAIM

This application claims priority under U.S. Provisional Application No. 60/333,820 filed Nov. 16, 2001.

### FIELD OF THE INVENTION

This invention relates to over-pressure protection for any ultra-high-pressure circuit, and ideally for water jet cutting systems driven by the mechanical type, fixed-displacement pump.

### BACKGROUND OF THE INVENTION

A plugged orifice or defective valve in an ultra-high-pressure circuit could block normal fluid flow and result in a nearly instantaneous pressure surge which could damage or destroy the pump, blow out a line component or the line itself. The typically used device at present to prevent damage due to accidental over-pressurization is the rupture disc. This component is a metal diaphragm subjected to the system pressure, and designed to fail at some pre-calculated pressure value. But, because of variables in metallurgy and manufacturing accuracy, the burst-pressure varies substantially. The rupture is accompanied by a large bang and sometimes a shower, and afterward, the disc must be replaced.

Use of the traditional spring-loaded poppet-seat arrangement widely used for pressure relief in hydraulic circuits is not practical for ultra-high-pressure application. Force required to seal the poppet at these high-pressure levels requires large pre-load springs accompanied by very high spring rates. When the spring is adjusted to maintain the poppet-seat seal at system pressure, cracking usually occurs at a substantially higher pressure. As the flow increases from cracking to full system flow, the stem is deflected away from the seat, further compressing the spring and because of the high spring rate increasing the poppet load and thus pressure on the water escaping from the seat. The resulting by-pass pressure could be as much as twice the original system pressure. This defeats the objective of pressure relief, and the sealing surfaces rapidly erode from the heat generated.

The valve of this invention eliminates the poppet seat problems described above producing full by-pass flow at cracking pressure as little as five to ten percent (5% to 10%) above system pressure with minimal heat generation and erosion.

### SUMMARY OF THE INVENTION

The unloading valve of this invention is comprised of a main body threaded on the upper and lower ends. Within the body and extending below is the cylindrical seat, tapered in the lower end, compatible with any standard high pressure fitting. The through hole is blocked at the upper end by a conical poppet secured to the lower end of the spring-loaded stem. The lower end of the stem is slightly below the hole through the body wall which vents the diverted flow. As system pressure increases and unseats the poppet against the spring force acting in the stem, fluid flows into the body cavity below the lower end of the stem. Pressure builds in the cavity until the resulting pressure force on the lower surface of the stem lifts it slightly past the vent hole, and fluid begins to escape through the vent hole. Stem pressure is immediately reduced to the pressure drop across the orifice formed by the lower stem surface partially blocking the vent. The resulting pressure acting on the lower surface of the stem balances the downward spring force. When the pump is shut off, the pressure in the cavity decays allowing the poppet to seat and again hold against normal system pressure.

### BRIEF DESCRIPTION OF THE DRAWINGS

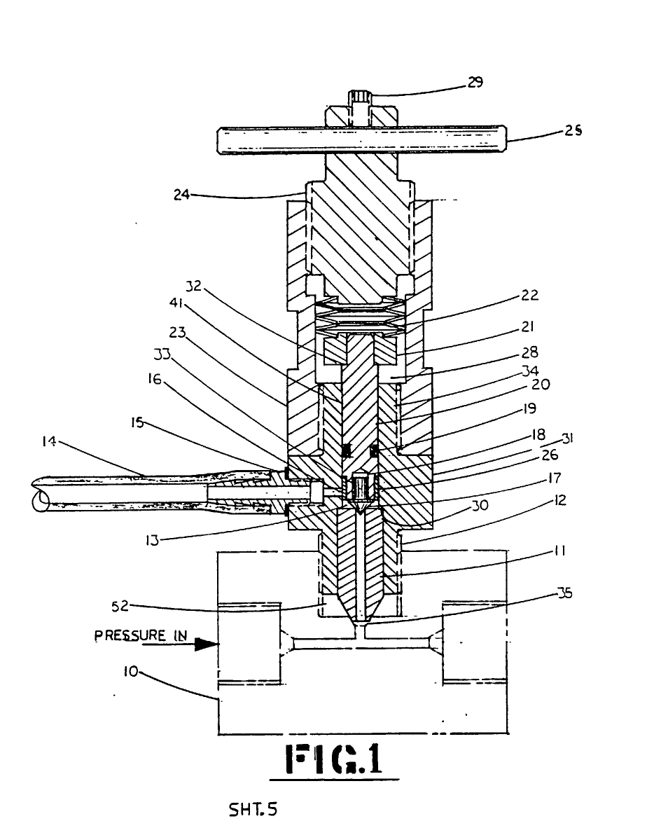

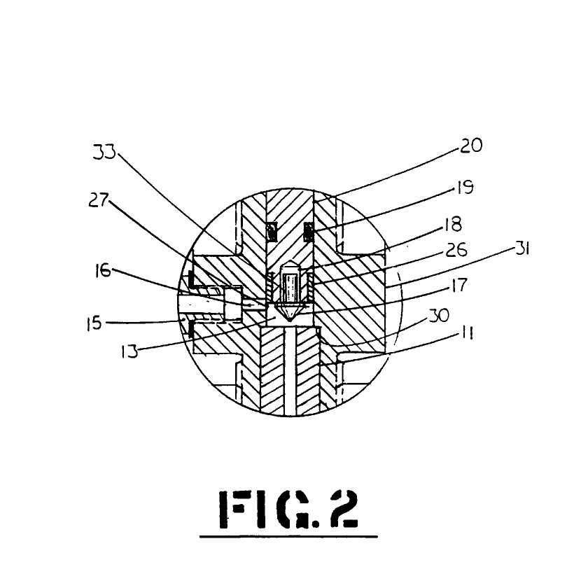

Two figures are shown. FIG. 1 is a cross-section of the valve, fitting, and outlet hose. FIG. 2 shows the seat-poppet-vent area with the poppet deflected to full by-pass position.

### DETAILED DESCRIPTION OF THE INVENTION

The ultra-high-pressure unloading valve of the invention is designed to screw into a standard ultra-high-pressure fitting 10, as shown in FIG. 1. The unloading valve includes a body 31, having a lower threaded nipple 12 and an upper threaded nipple 34. A seat 11 fits into a counterbore inside of the lower threaded nipple 12, up to a shoulder 30 within the body. The seat is tapered at its lower end in compatibility with a counter sunk hole 35 in the high pressure fitting, and seals at the shoulder 30 above and in said counterbore 35 below when the lower threaded nipple is screwed and torqued into a threaded port 52 of the ultra-high-pressure fitting.

The seat 11, so located and sealed, provides high-pressure fluid communication between the ultra-high-pressure fitting 10 connected into a high-pressure circuit, and a poppet 17, blocking said high-pressure flow. A spring set 22 provides the force to hold the poppet in sealing position, said force transferred from said spring set 22 through a spring guide 21 and a stem 20 to said poppet. Preferably the spring set is a belleville spring set. Spring force is adjustable by rotating the adjustment screw 24 within a spring housing 23 screwed on to the upper threaded nipple 34 of the body 31. In an embodiment, the adjustment screw is rotated using a tee handle 25. Other devices for rotating the adjustment screw are also contemplated, and considered to be within the scope of the invention. A short upwardly extending stem 33 from the top of the poppet 17 into the hole 18 in the lower surface of the stem 20, the hole being slightly larger in diameter than said stem 20, allows sufficient radial movement of the poppet to perfectly line up in said seat 11 while still maintaining squareness when the valve closes. This accommodates any misalignment of the internal features within the valve body 31.

A bushing 26 is pressed onto the end of the stem 20 providing a very close sliding fit inside of the upper bore of the body 31. Preferably, the bushing is a bronze bushing, although other alloys or materials may also be used. The lower edge of the bushing is slightly below a vent hole 16 provided in the body when the poppet 17 is fully engaged in the seat 11.

The unloading valve is adjusted for overload protection at system pressure by relieving spring force on the poppet 17. The adjustment screw 24 in the spring housing 23 is unscrewed, reducing the spring force until a slight weep shows at the exit of an outlet fitting 15, then slightly re-tightened until weep stops. Pressure increase in the high-pressure circuit then slightly lifts the poppet 17 against the pre-load spring force creating leakage past the poppet, filling and pressurizing an interior cavity 13. Pressure builds within the interior cavity until the pressure force on the lower area of the stem 20, further exceeds the spring force and the poppet and stem move further away from the seat 11, until the lower edge of the bushing 26 begins to uncover the vent hole 16. This forms a small escape orifice area 27, into the vent hole. The stem continues to move, further uncovering the vent hole and increasing the escape orifice area until the pressure drop across the equivalent escape orifice area, said pressure acting on the lower area of the stem, exactly balances the spring force acting on the stem and poppet at this deflection of said spring set 22. High pressure fluid is prevented from leaking into the spring cavity 23 by O-ring 19 mounted in the stem above the vent hole. In an additional embodiment, the escape orifice area of the vent hole developed by the movement of the stem uncovering the vent hole can be duplicated by a drilled hole having that area, resulting in the same unloading function. Preferably, the vented fluid flows through the vent hole into the outlet fitting 15, and flows further through an outlet hose 14 to prevent a sharp “pop” at opening. System pressure immediately decays to less than approximately ten percent (10%) of original system pressure and continues to dump until the system is shut down. After relieving the circuit obstruction, pump restart restores system pressure.

What is claimed is:

1. An unloading valve for ultra-high-pressure applications, substantially as shown and described herein.
